(19) United States
(12) Patent Application Publication
(10) Pub. No.: US 2013/0083170 A1
(43) Pub. Date: Apr. 4, 2013

(54) STEREOSCOPIC IMAGE PICKUP APPARATUS

(71) Applicant: CANON KABUSHIKI KAISHA, Tokyo (JP)

(72) Inventor: Junji SHIGETA, Utsunomiya-shi (JP)

(73) Assignee: CANON KABUSHIKI KAISHA, Tokyo (JP)

(21) Appl. No.: 13/644,087

(22) Filed: Oct. 3, 2012

(30) Foreign Application Priority Data
Oct. 3, 2011 (JP) 2011-219528

(51) Int. Cl. H04N 13/02

(52) U.S. Cl. 348/47; 348/E13.075

(57) ABSTRACT

A stereoscopic image pickup apparatus includes: two optical systems arranged having binocular disparity; image pickup units for shooting images of an object from the optical systems; a convergence angle driver for changing directions of optical axes of the optical systems, and changing intersection distances from the optical systems to a position at which the optical axes of the optical systems intersect with each other; an object distance detector for detecting object distance; an intersection distance controller for computing the intersection distance in fusion limit range that is a stereoscopically viewable range based on the object distance and image pickup condition; and a convergence angle controller for controlling the convergence angle driver based on the object distance and a track delay amount set to cause the intersection distance fall within the fusion limit range such that the intersection distance tracks the object distance with a delay by the track delay amount.

### BACKGROUND OF THE INVENTION

1. Field of the Invention

The present invention relates to a stereoscopic image pickup apparatus and, in particular, to control on an angle of convergence.

2. Description of the Related Art

Conventionally, a method has been known that changes the angle between optical axes of right and left lenses (hereinafter referred to as angle of convergence) in stereoscopic image pickup to adjust a stereoscopic effect of a stereoscopic image to be taken.

However, if the angle of convergence is changed when the stereoscopic video is taken, the stereoscopic video becomes unnatural, which sometimes makes a cameraperson and a viewer feel uncomfortable. Furthermore, if the angle of convergence is abruptly changed, stereoscopic views of the cameraperson and the viewer cannot follow the change. The resultant image causes the cameraperson and the viewer feel uncomfortable.

To solve the problems, for instance, following conventional arts have been disclosed.

Japanese Patent Application Laid-Open No. 2001-16614 discloses a stereoscopic image pickup apparatus that measures the distance to an object and automatically performs a focusing operation and controls the angle of convergence based on the measured value and that increases the driving speed of the angle of convergence after the focusing operation is switched to a manual operation, in comparison with the case of automatic focusing operation. It is also described that the driving speed of the angle of convergence after the focusing operation is switched to the manual operation is a driving speed within a degree that does not make a cameraperson uncomfortable. Accordingly, the focus and the convergence point (the point on which the optical axes of right and left lenses intersect with each other) coincide with each other, and a video that does not cause uncomfortable feeling can be taken. Furthermore, driving is not performed at a driving speed that makes the cameraperson uncomfortable. Accordingly, the video does not cause uncomfortable feeling.

Japanese Patent Application Laid-Open No. 2001-16615 discloses a stereoscopic image pickup apparatus that measures the distance to an object and controls the angle of convergence based on the measured value and that reduces the driving speed of the angle of convergence in comparison with a normal speed when the change between the measured distance value at this time and the measured distance value at the last time. Accordingly, as with Japanese Patent Application Laid-Open No. 2001-16614, the focus and the convergence point coincide with each other, and a video that does not cause uncomfortable feeling can be taken. In the case where the angle of convergence is required to be largely changed, the changing speed is reduced so as not to make a cameraperson and a viewer uncomfortable.

Japanese Patent Application Laid-Open Nos. 2001-16614 and 2001-16615 thus describe that the angle of convergence is changed at a driving speed within a degree that does not make the cameraperson and the viewer uncomfortable, but do not describe a specific speed. Furthermore, the gazettes do not describe control of the angle of convergence so as to smoothly change the protrusion amount of a stereoscopic video in response to the motion of an object within a stereoscopically viewable range.

Moreover, comfortable stereoscopic view roughly requires following factors. A first factor is a fusion limit in which a view is stereoscopically recognized based on the parallax between right and left eyes. Although there are differences between individuals, a parallactic angle within ±2° is desirable. Here, the fusion limit, the parallactic angle and the angle of convergence are described. A human being has two eyes disposed apart horizontally by about 6 cm. Accordingly, in certain spatial arrangement of an object, images formed on the retinae of respective eyes slightly differ from each other. The difference between images is called a parallax. Here, the angle formed by intersection between the lines of sight of both eyes is called an angle of convergence. The difference between the angle of convergence where the lines of sight intersect with each other on a screen for displaying a stereoscopic video and the angle of convergence where lines of sight intersect with an apparent stereoscopic image position is called a parallactic angle. If the parallactic angle is within a certain range, the images on both eyes are recognized as a single image (fusion). If the parallactic angle exceeds the certain range, the images are recognized as separate images (double image). The boundary between the fusion and double image is a fusion limit. The parallactic angle to be the fusion limit is ±2° at the average. Accordingly, it is required to take a stereoscopic video such that the parallactic angle is within ±2°.

A second factor is a proper parallax range for allowing a comfortable stereoscopic view. Although there are differences between individuals, a parallactic angle within ±1° is desirable. A third factor is a miniature garden effect. According to this phenomenon, the stereoscopically viewed image is recognized as being smaller than the actual size and nearer than the actual position. A fourth factor is a cardboard effect. According to this effect, the depth between an object and the background can be sensed. However, the stereoscopic structure of the object itself cannot be sensed. Instead, the object is sensed flat. However, above-mentioned Japanese Patent Application Laid-Open Nos. 2001-16614 and 2001-16615 do not describe control of the angle of convergence in consideration of the conditions.

### SUMMARY OF THE INVENTION

Thus, the present invention provides a stereoscopic image pickup apparatus that controls the angle of convergence in consideration of a plurality of conditions so as to smoothly change the protrusion amount of a stereoscopic video in response to the motion of an object within a stereoscopically viewable range.

A stereoscopic image pickup apparatus of the present invention includes: two optical systems arranged having a binocular disparity; image pickup units for picking up images of an object from the respective two optical systems; a convergence angle driver for changing directions of optical axes of the two optical systems, and changing intersection distances from the two optical systems to a position at which the optical axes of the two optical systems intersect with each other; an object distance detecting unit for detecting an object distance information that is an information on an object distance; an intersection distance controller for computing the intersection distance in a fusion limit range that is a stereoscopically viewable range based on the object distance and an image pickup condition; and a convergence angle controller for controlling the convergence angle driver based on the object distance and a track delay amount set to cause the intersection distance fall within the fusion limit range such that the intersection distance tracks the object distance with a delay by the track delay amount.

The present invention can provide a stereoscopic image pickup apparatus that controls the angle of convergence in consideration of a plurality of conditions so as to smoothly change the protrusion amount of a stereoscopic video in response to the motion of an object within a stereoscopically viewable range.

Further features of the present invention will become apparent from the following description of exemplary embodiments with reference to the attached drawings.

### BRIEF DESCRIPTION OF THE DRAWINGS

FIG. 1 is a configurational block diagram of a first embodiment.

FIG. 2 is a diagram illustrating an image pickup condition.

FIG. 3A is a diagram of relationship between the optical axis and a shot image in one image pickup device.

FIG. 3B is a diagram of relationship between the optical axis and a shot image in one image pickup device.

FIG. 4A is a diagram of relationship between the optical axis and a shot image in the stereoscopic image pickup apparatus.

FIG. 4B is a diagram of relationship between the optical axis and a shot image in the stereoscopic image pickup apparatus.

FIG. 4C is a diagram of relationship between the optical axis and a shot image in the stereoscopic image pickup apparatus.

FIG. 5A is a diagram illustrating relationship between the optical axis and an image pickup displacement amount.

FIG. 5B is a diagram illustrating relationship between the optical axis and an image pickup displacement amount.

FIG. 5C is a diagram illustrating relationship between the optical axis and an image pickup displacement amount.

FIG. 6 is a diagram illustrating a viewing condition.

FIG. 7A is a diagram illustrating image displacement amount due to a screen size.

FIG. 7B is a diagram illustrating image displacement amount due to a screen size.

FIG. 8 is a flowchart of calculating a target intersection distance.

FIG. 9 is a tracking graph of the object distance and the intersection distance.

FIG. 10 is a tracking graph of the object distance and the intersection distance in consideration of the tracking offset.

FIG. 11 is a configurational block diagram of a second embodiment.

### DESCRIPTION OF THE EMBODIMENTS

Exemplary embodiments of the present invention will hereinafter be described in detail based on accompanying drawings.

### Embodiment 1

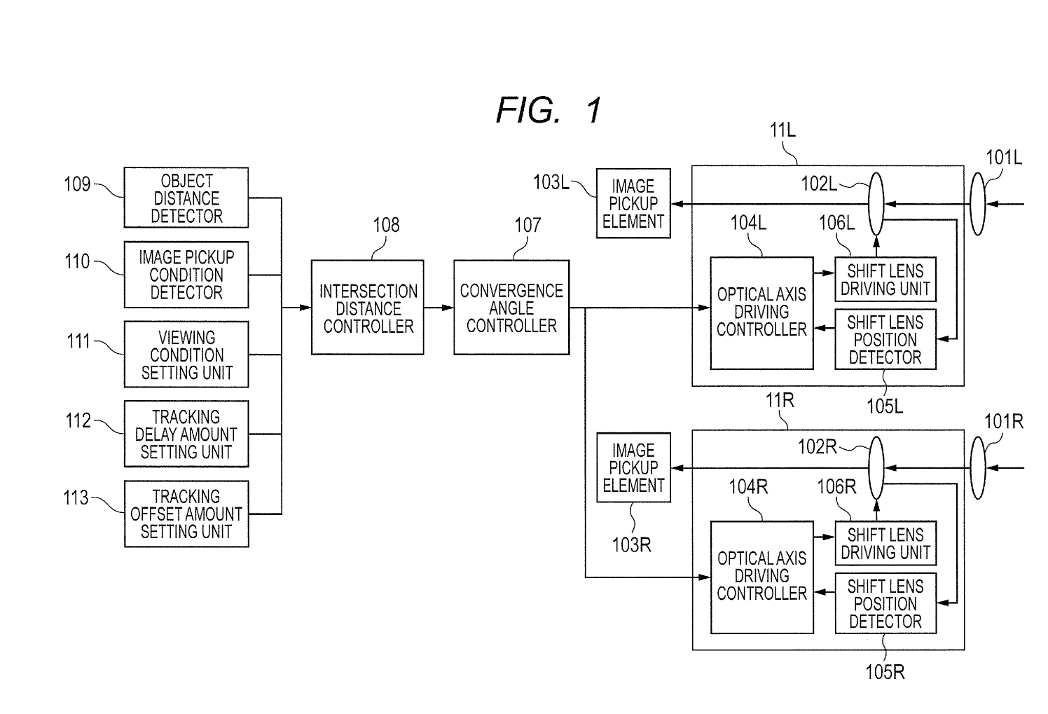

Hereinafter, referring to FIG. 1, a stereoscopic image pickup apparatus of a first embodiment of the present invention will be described.

FIG. 1 is a configurational block diagram of Embodiment 1. In FIG. 1, optical axis varying units 11L and 11R vary the optical axes for images for left and right eyes, respectively, and have the same configuration.

The optical axis is the optical path of a light beam perpendicularly incident on the center of an image pickup element, or the optical path of a light beam passing through the center of an aperture in a light flux incident on the center of the image pickup element. More specifically, in FIG. 1, the optical axis of the optical system for a left eye is the optical path of a light beam perpendicularly incident on the center of an image pickup element 103L for a left eye through an optical system 101L, 102L for a left eye, or the optical path of a light beam passing through the center of an aperture in a light flux incident on the image pickup element 103L. Likewise, the optical axis of an optical system for a right eye is the optical path of a light beam perpendicularly incident on the center of an image pickup element 103R for a right eye through an optical system 101R, 102R for a right eye, or the optical path of a light beam passing through the center of an aperture in a light flux incident on the image pickup element 103R.

The optical systems for left and right eyes include object lenses 101L and 101R and shift lenses 102L and 102R, respectively. The object lenses 101L and 101R are for capturing light for images for left and right eyes, respectively. The shift lenses 102L and 102R are for varying the respective optical axes. The image pickup elements 103L and 103R are for picking up images for left and right eyes, respectively, and serve as a convergence angle driving unit for changing the angle of convergence. Optical axis driving controllers 104L and 104R are for driving and controlling the shift lenses 102L and 102R, respectively.

Shift lens position detectors 105L and 105R are for detecting the current positions of the shift lenses 102L and 102R, respectively, and is, for instance, hole devices. Shift lens driving units 106L and 106R are drive means for driving the shift lenses 102L and 102R, respectively, and are, for instance, voice coil motors.

A convergence angle controller 107 is a unit for controlling the angle of convergence that controls the angle of convergence using the optical axis varying units 11L and 11R. An intersection distance controller 108 is an intersection distance controller for computing intersection distances that are the distances between the intersection of the optical axes of the optical axis varying units 11L and 11R and the object lenses 101L and 101R. An object distance detector 109 is an object distance detecting unit for calculating the distances between the object lenses 101L and 101R and an object. An image pickup condition detector 110 is an image pickup condition detection unit for detecting an image pickup condition. The image pickup condition will be described later.

A viewing condition setting unit 111 is a viewing condition setting unit for setting a viewing condition, and includes, for instance, a setting display and a switch. The viewing condition will be described later. A tracking delay amount setting unit 112 is a track delay setting unit for setting a track delay amount of the intersection distance to the object distance, and includes, for instance, a setting display and a switch. A tracking offset amount setting unit 113 is a tracking offset amount setting unit for setting a tracking offset amount between the intersection distance and the object distance, and includes, for instance, a setting display and a switch. In this specification, the object distance is the distance from the line connecting the object lenses 101L and 101R of the left and right image pickup devices to the object.

An object distance detector 109 detects object distance information and outputs the information to the intersection distance controller 108. Here, the object distance information is calculated based on a focus position. Instead, a distance measurement unit may be separately provided, and the object distance information may be calculated based on measured information on the object. Instead, an auto focus unit may be provided, and the object distance information may be calculated from the focus position by auto focus.

An image pickup condition detector 110 detects image pickup condition information and outputs the information to the intersection distance controller 108. The image pickup condition will be described later. A viewing condition setting unit 111 outputs the set viewing condition information to the intersection distance controller 108. The viewing condition will be described later. A track delay amount setting unit 112 outputs the set track delay amount to the intersection distance controller 108. The track delay amount is a coefficient of a low-pass filter (LPF) used for causing the intersection distance to track the object distance and applied on the difference between the object distance and the intersection distance. The control of causing the intersection distance to track the object distance will be described later. A track offset amount setting unit 113 outputs a tracking offset amount between the set object distance and the intersection distance to the intersection distance controller 108. The track offset amount will be described later.

The intersection distance controller 108 computes a target intersection distance, which is a target position of the intersection distance per unit time, based on the input image pickup condition information, viewing condition information, track delay amount and track offset amount, and outputs the computed distance to the convergence angle controller 107. A method of calculating the target intersection distance will be described later. The convergence angle controller 107 converts the target intersection distance into a target angle of convergence. A method of converting the target intersection distance into the target angle of convergence will be described later. The convergence angle controller 107 further computes shift lens drive positions L and R, which are drive positions of the shift lenses 102L and 102R, based on the target angle of convergence, and outputs the positions to the respective optical axis driving controllers 104L and 104R. A method of calculating shift lens drive positions L and R will be described later.

The optical axis driving controllers 104L and 104R control driving such that the shift lenses 102L and 102R are driven to the shift lens drive positions L and R, respectively. More specifically, the controllers output driving instructions to the shift lens driving units 106L and 106R such that the positions of the shift lenses 102L and 102R output from the shift lens position detectors 105L and 105R coincide with the shift lens drive positions L and R, respectively.

Light having entered the object lens 101L passes through the shift lens 102L, forms an image on the image pickup element 103L and is output as an image pickup signal IL. Light having entered the object lens 101R passes through the shift lens 102R, forms an image on the image pickup element 103R and is output as an image pickup signal IR.

As described above, picked up images having the intersection distance computed by the intersection distance controller 108 are output.

Next, image pickup for a stereoscopic image will be described.

The image pickup signals IL and IR become an image pickup signal I having an image pickup displacement amount ΔI in the horizontal direction according to the object distance, based on a base length a, which is the distance between the object lenses 101L and 101R, and intersection distance c. A viewer views the image of the image pickup signal IL by the left eye and views the image of the image pickup signal IR by the right eye to thereby recognize that a virtual image exists at a distance according to the image pickup displacement amount ΔI.

First, the relationship between the intersection distance c, optical axes VL and VR and the base length a will be described.

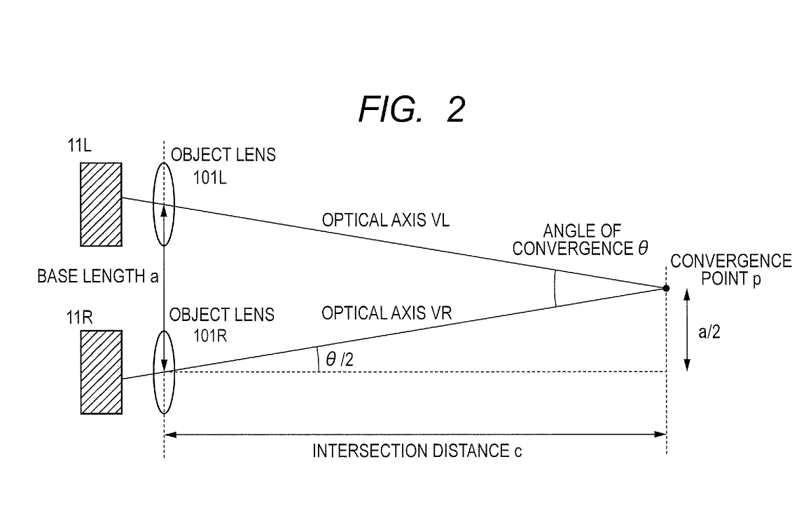

FIG. 2 is a diagram illustrating the relationship among the object lenses 101L and 101R, the intersection distance c, the base length a, the optical axes VL and VR, a convergence point p and an angle of convergence θ.

Here, the optical axis VL is the optical axis of light which forms an image on the image pickup element 103L. The optical axis VR is the optical axis of light which forms an image on the image pickup element 103R.

The base length a is the distance between the optical axes in the image pickup apparatus. More specifically, the distance between the center of the object lens 101L and the center of the object lens 101R.

The convergence point p is a point where the optical axes VL and VR intersect with each other.

The angle of convergence θ is an angle formed by the optical axes VL and VR intersecting each other on the convergence point p.

The intersection distance c is the distance from the line connecting the object lenses 101L and 101R of the left and right image pickup devices to the convergence point p.

The relationship among the base length a, the angle of convergence θ and the intersection distance c is represented by the equation (1).

tan(θ/2)=(a/2)/c (1)

Next, variation of the image pickup signals IL and IR due to the variation of the optical axes VL and VR will be described. Hereinafter, the relationship between the optical axis VL and the image pickup signal IL will be described. The relationship between the optical axis VR and the image pickup signal IR is analogous thereto.

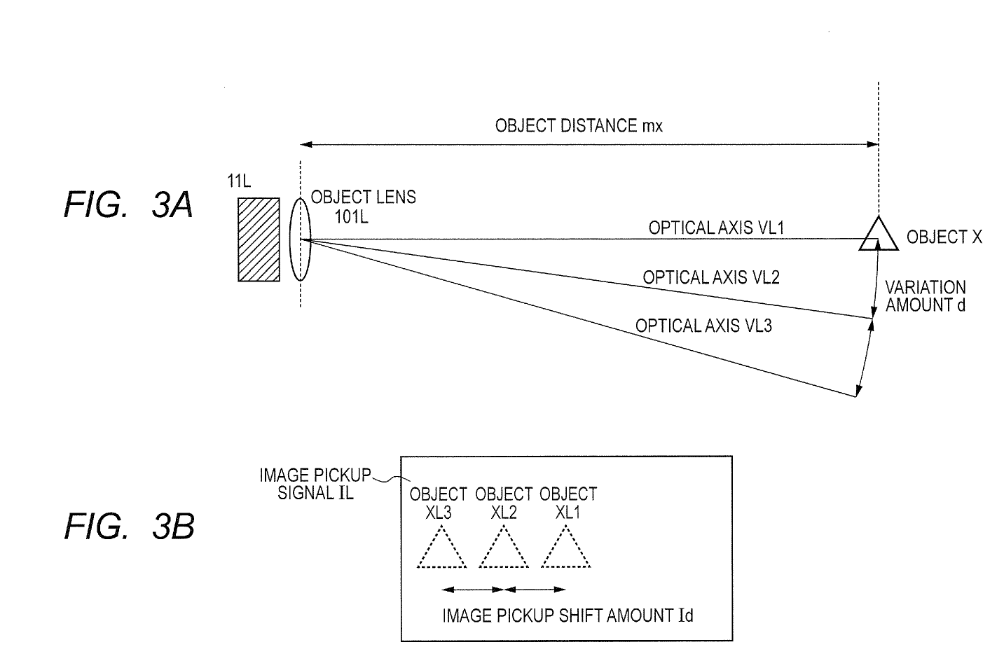

FIGS. 3A and 3B illustrate the relationship between the optical axis VL and the image pickup signal IL obtained while the shift lens 102L is moved. Here, the shift lens 102L is driven such that the optical axis VL is moved in the direction where the object lenses 101L and 101R are disposed.

Optical axes VL1, VL2 and VL3 are the optical axis VL when the shift lens 102L is moved. A variation amount d is the variation amount of the angle formed by the optical axis VL. Here, the optical axis VL where the convergence is adjusted such that an object X intersects with the optical axis is the optical axis VL1. An optical axis driven from the optical axis VL1 to the right by the variation amount d is the optical axis VL2. An optical axis driven from the optical axis VL2 to the right by the variation amount d is the optical axis VL3.

The object X is an object to be shot. Objects XL1, XL2 and XL3 indicate positions of the object X in the image pickup signal IL when the optical axis VL is the optical axis VL1, the optical axis VL2 and the optical axis VL3, respectively.

An image pickup shift amount Id is an amount of shift of the object in the image pickup signal IL (on the image pickup element 103L) when the optical axis angle is varied by the variation amount d under control of the intersection distance.

An object distance mx is the distance between the object X and the object lens 101L.

That is, in the case where the variation amount d of the optical axis angle is constant, the image pickup shift amount Id of the object in the shot image becomes constant.

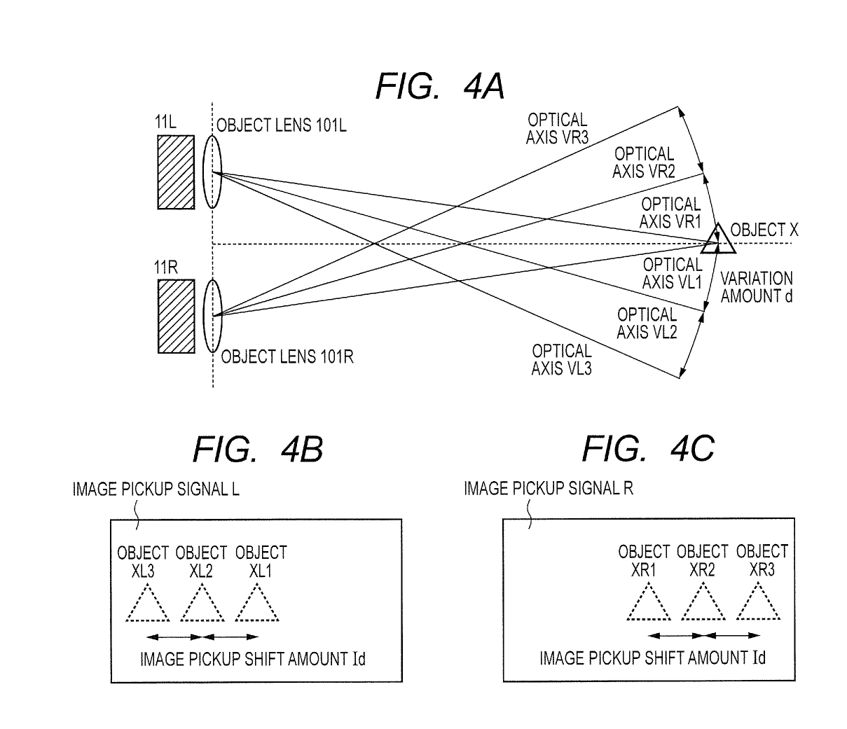

FIGS. 4A, 4B and 4C illustrate the details, as with FIGS. 3A and 3B, for both the image pickup signals IL and IR.

The optical axes VR1, VR2 and VR3 indicate positions of the optical axis VR for the respective optical axes VL1, VL2 and VL3. Here, the optical axis VR is driven in the direction to the object lens 101L by the same amount of the degree as that of the optical axis VL such that the convergence point p always resides on the central line between the object lenses 101L and 101R.

Thus, as with FIG. 4A, according to variation of the optical axis VL to the optical axes VL1, VL2 and VL3, the optical axis VR varies to the optical axes VR1, VR2 and VR3. Furthermore, as with FIG. 4B, as the object X in the image pickup signal IL varies to the objects XL1, XL2 and XL3, the object X in the image pickup signal IR varies to objects XR1, XR2 and XR3 as illustrated in FIG. 4C. Here, the objects XL1, XL2 and XL3 in the image pickup signal IR are at the respective positions varied by the same image pickup shift amount in the direction opposite to the objects XL1, XL2 and XL3 in the image pickup signal IL.

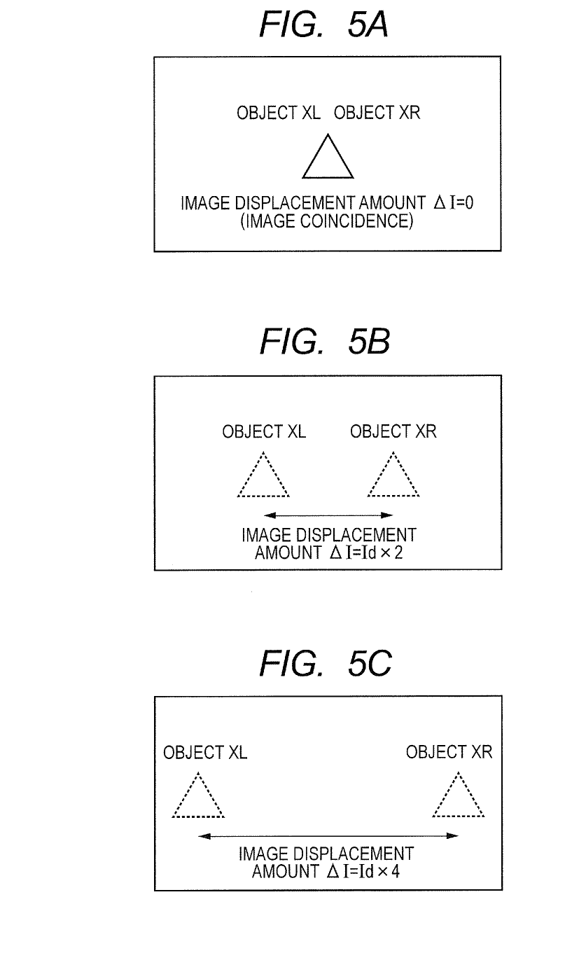

FIGS. 5A, 5B and 5C are diagrams illustrating image pickup signal LR in the case where the image pickup signal IL and video signal R in FIGS. 4A, 4B and 4C are superposed on each other. Here, FIGS. 5A, 5B and 5C indicate the image pickup signal LR for the respective optical axes VL1, VL2 and VL3. In FIG. 5A, the positions of the convergence point p and the object X coincide with each other. Accordingly, the image displacement amount ΔV between the left and right images is zero, and the object images coincide with each other. In FIG. 5B, the objects XL2 and XR2 are varied, by the image pickup shift amount Id, from the respective positions of the objects XL1 and XR1. Accordingly, the image pickup displacement amount ΔI between the left and light picked up images is an image pickup shift amount Id×2. In FIG. 5C, the objects XL3 and XR3 are varied from the positions of the video-shifted objects XL1 and XR1 by the image pickup shift amount Id×2, respectively. Accordingly, the image displacement amount ΔV between the left and right picked up images is Id×4.

As described above, the image pickup signal I having the predetermined image pickup displacement amount ΔI in the horizontal direction can be obtained according to the intersection distance c and the object distance mx.

Next, a stereoscopic virtual image x where the image pickup signal I is displayed as an image signal V and the image signal V is viewed will be described.

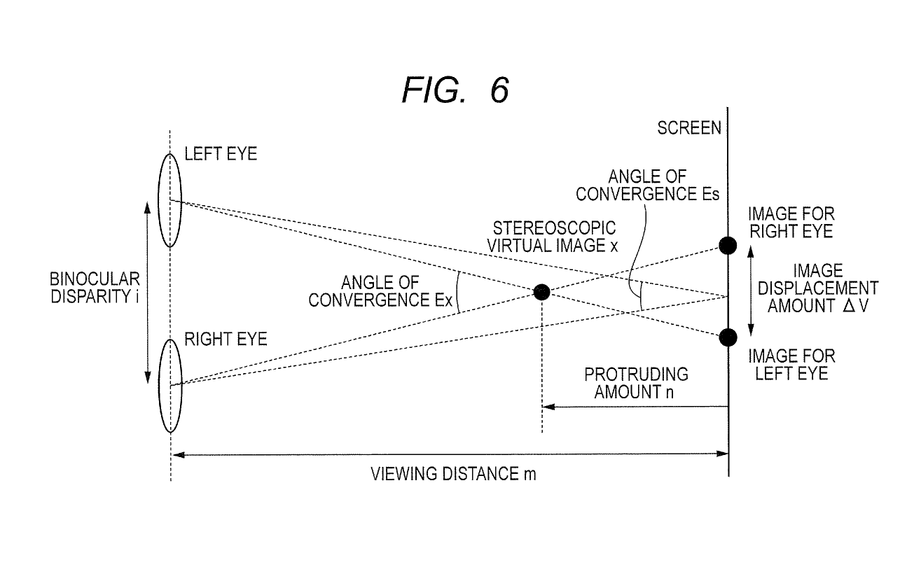

FIG. 6 illustrates the relationship between a screen, which is a video display, and a viewer, in viewing. A binocular disparity i is the distance between the right and left eyes of the viewer. An image displacement amount ΔV is an displacement amount of the positions on a screen between an image for the right eye and an image for the left eye in the stereoscopic virtual image x. A viewing distance m is the distance between the viewer and the screen surface. An angle of convergence Ex is the angle of convergence to the stereoscopic virtual image x. An angle of convergence Es is an angle of convergence to the screen surface.

The stereoscopic virtual image x is the intersection between the line connecting the left eye and the image for the left eye on the screen and the line connecting the right eye and the image for the right eye on the screen. The viewer recognizes that the object is at the position of the stereoscopic virtual image x owing to an optical illusion. The protrusion amount n corresponds to the distance from the screen to the stereoscopic virtual image x, and is acquired according to the following equation (2).

n=(ΔV/(i+ΔV))×m (2)

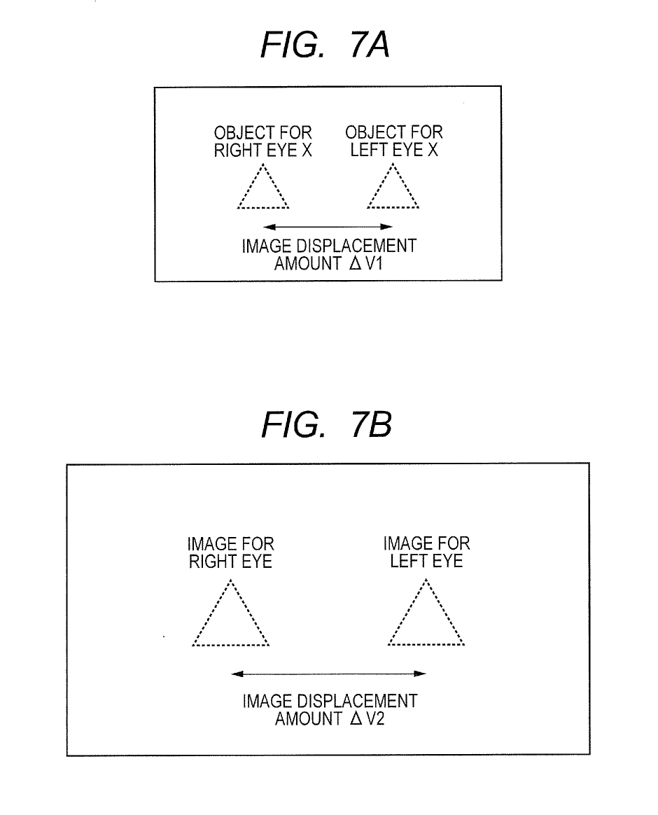

Since the pupil distance (binocular disparity) i between the eyes can be approximated to be constant, it can be understood, according to the equation (2), that the protrusion amount n is varied according to the viewing distance m and the image displacement amount ΔV. Even in the case of displaying the same image (image having the image pickup displacement amount ΔI in FIG. 6), the image displacement amount ΔV on the displayed image varies according to the screen size. The image displacement amount ΔV1 (FIG. 7A) in the case of displaying the image in FIG. 6 on a small screen is smaller than the image displacement amount ΔV2 (FIG. 7B) in the case of displaying the same image in FIG. 6 on a large screen. Accordingly, the protrusion amount n recognized by the viewer varies according to the viewing distance m and the screen size even if the taken stereoscopic image is the same.

As described above, the protrusion amount n is determined based on the image displacement amount ΔV and the viewing distance m. The image displacement amount ΔV is determined based on the image pickup displacement amount ΔI and the screen size or a display magnification ratio (magnification ratio of a viewed image) of the shot image I.

The image pickup condition will hereinafter be described.

According to the equation (2), the protrusion amount n of the stereoscopic virtual image x depends on the image displacement amount ΔV. Furthermore, the image displacement amount ΔV depends on the image pickup displacement amount ΔI and the screen size.

Accordingly, upon picking up an image, what affects the protrusion amount n is the image pickup displacement amount ΔI. The image pickup displacement amount ΔI depends on the angle of convergence θ or the intersection distance c, the object distance mx and the angle of view. Accordingly, upon picking up an image, parameters affecting the protrusion amount n are the angle of convergence θ or the intersection distance c, the object distance mx and the angle of view. Further, since the viewer recognizes stereoscopic virtual images for focused objects other than the main object to be imaged, the depth of field in which the in-focus state is obtained is required to be considered.

More specifically, the case is assumed where the tracking error Δm with respect to the intersection distance c is the maximum on all object distances in a range of object distances within the depth of field, and the intersection distance c, i.e. the directions of the optical axes of the left and right lenses, is controlled. Stereoscopic virtual images x are sometimes recognized also on objects out of the depth of field. Accordingly, in actuality, the object distance mx where the difference between the object distance and the intersection distance c is the maximum is determined in a range where a predetermined distance range is added to the range of the object distance in the depth of field.

The variation amount of the object distance Xm in a prescribed time may be recorded, and a variation estimation range of the object distance Xm may be expected based on the variation amount in the prescribed time. In this case, an object distance mx where the difference between the object distance and the intersection distance c is the maximum is determined in the variation estimation range of the object distance Xm.

The intersection distance controller 108 computes the intersection distance derived from the image pickup condition where the image pickup displacement amount ΔI falls within a prescribed range. Typically, a range where the difference between the angle of convergence Ex and the angle of convergence Es is within ±2° is a stereoscopically viewable range, i.e. a fusion limit range. Accordingly, the intersection distance c where the difference between the angle of convergence Ex and the angle of convergence Es falls within ±2° is computed.

The viewing condition will hereinafter be described.

According to the equation (2), the protrusion amount n of the stereoscopic virtual image x depends on the pupil distance i between the eyes, the viewing distance m and the image displacement amount ΔV. The image displacement amount ΔV is proportional to the screen size or the image magnification ratio. Accordingly, the viewing conditions affecting the protrusion amount n are the pupil distance i between the eyes, the viewing distance m, and the screen size or the video magnification ratio.

The intersection distance controller 108 performs control such that the image pickup displacement amount ΔI derived from the image pickup condition and the viewing condition falls within a prescribed range. Typically, a range where the difference between the angle of convergence Ex and the angle of convergence Es is within ±2° is a stereoscopically viewable range, i.e. a fusion limit range. Accordingly, the intersection distance c is controlled such that the difference between the angle of convergence Ex and the angle of convergence Es falls within ±2°.

Tracking control of the intersection distance c with respect to the object distance mx will hereinafter be described.

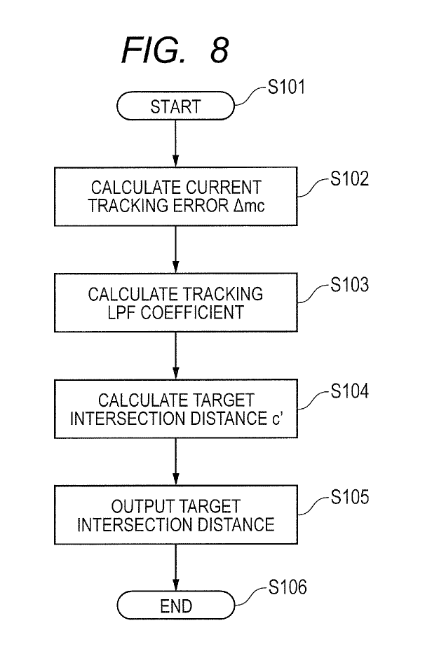

FIG. 8 is a flowchart illustrating a process of calculating a target intersection distance c′ per unit time in the intersection distance controller 108.

The processing is started in S101 and proceeds to S102.

In S102, a current tracking error Δmc is calculated according to the equation (3).

Δmc=Xm−c (3)

Here, Xm is the object distance, and c is the intersection distance. The intersection distance c is the same value as that of the last target intersection distance c′.

After the current tracking error Δmc is calculated in S102, the processing proceeds to S103.

In S103, a tracking LPF coefficient to be applied to the tracking error Δmc is determined.

The LPF coefficient is determined based on a set value (track delay amount) from the tracking delay amount setting unit 112. Furthermore, in the case where the tracking error Δmc exceeds the fusion limit range computed by the intersection distance controller 108, the coefficient may be switched to a coefficient to improve trackability. More specifically, the tracking LPF coefficient is determined based on the set value from the tracking delay amount setting unit 112 such that the cut-off frequency becomes high.

After the tracking LPF coefficient is calculated in S103, the processing proceeds to S104.

In S104, the target intersection distance c′ is calculated.

A digital filter computation is executed on the tracking error Δmc calculated in S102 based on the tracking LPF coefficient determined in S103, and adds the last target intersection distance c′ to the output value to thus calculate the target intersection distance c′.

Here, in the case where the tracking LPF coefficient is varied, the digital filter may be initialized once to prevent a digital filter computation result from being mismatched.

After the target intersection distance c′ is calculated in S104, the processing proceeds to S105.

In S105, the target intersection distance c′ calculated in S104 is output to the convergence angle controller 107, the processing proceeds to S106.

In S106, the processing ends.

Here, in S102, the intersection distance c is the last target intersection distance c′. However, the intersection distance c may be calculated from the positions of the shift lenses 102L and 102R calculated from the shift lens position detectors 105L and 105R.

As described above, as illustrated in FIG. 9, the intersection distance c tracks the object distance Xm with a certain delay to the object distance Xm. Furthermore, in the case where the tracking error Δm is out of the fusion limit range or approaches this limit, the tracking error Δm is controlled to fall within the fusion limit range by improving the trackability.

A unit for determining a stereoscopic view proper range, which is the range of the intersection distance, (stereoscopic view proper range determination unit) may be provided. The determination is made such that the protrusion amount, or the protrusion amount and a protrusion duration, which is a duration in which the protrusion amount is in a certain state, falls within a prescribed range, based on the protrusion amount, or the protrusion amount and the protrusion duration. The intersection distance may be controlled to track the object distance such that the stereoscopic view proper range is satisfied. Thus, an allowable range is set on the protrusion amount and the protrusion duration. Accordingly, a proper stereoscopic image that hardly causes the viewer to feel uncomfortable can be obtained by a limitation being imposed on a duration in which the protrusion amount is out of the fusion limit range, even with a motion picture including a case where the protrusion amount is out of the fusion limit range.

A unit for calculating a range of variation of the object distance Xm from variation of the object distance Xm in a past prescribed time may be provided, so that the tracking LPF coefficient may be determined such that the protrusion amount does not exceed the fusion limit range. In this case, a method may be adopted according to which the maximum tracking error which is the possible maximum value for the tracking error Δm calculated from the intersection distance c and the range of variation of the object distance Xm, and the tracking LPF coefficient to improve the trackability may be set as the maximum tracking error becomes larger. That is, the maximum tracking error (track delay amount, tracking error amount) may be determined based on the variation of the object distance in the past prescribed time (variation relative to the intersection distance) or the variation of the object distance relative to the fusion limit range, and the tracking error amount may be determined to perform the tracking operation based on the tracking error amount. Accordingly, an image pickup can be performed in consideration of the fusion limit range and the stereoscopic view proper range that are optimized with respect to the object movement.

The tracking offset amount will hereinafter be described.

The fusion limit range affects the difference between the angle of convergence Ex and the angle of convergence Es. In the case where the stereoscopic virtual images x in front of and beyond the screen have the protrusion amount n with the same distance, the image beyond the screen has a smaller variation of the angle of convergence Ex relative to the protrusion amount n. Accordingly, the fusion limit range is wider in the case of the stereoscopic virtual image x beyond the screen than in the case of the virtual image in front of the screen. That is, the fusion limit range can be configured wider in the case where the object distance Xm is beyond the intersection distance c.

Accordingly, in controlling the intersection distance c to tracking the object distance Xm, the tracking can be easily controlled within the fusion limit range if the tracking is performed with an offset by a tracking offset amount Δmo from the object distance Xm toward the near side in consideration of the time lag of control.

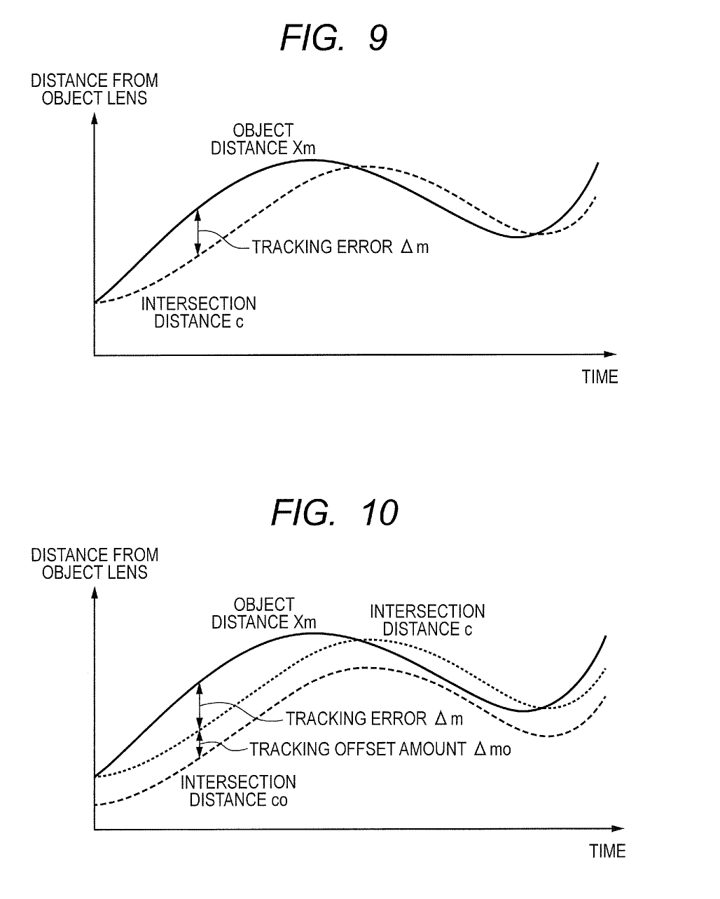

FIG. 10 is a diagram illustrating a state of tracking control where the intersection distance co is set at a position shifted by the tracking offset amount Δmo with respect to the control illustrated in FIG. 9, and the target intersection distance c′ is set to the intersection distance co.

In actuality, a value acquired by adding the tracking offset amount Δmo output from the tracking offset amount setting unit 113 to the target intersection distance c′ calculated in S104 is output as the target intersection distance c′ to the convergence angle controller 107.

As described above, an image having the protrusion amount n dependent on the tracking offset amount Δmo set by the tracking offset amount setting unit 113 can be picked up.

The method of converting the target intersection distance into the target position of the angle of convergence will hereinafter be described.

The angle of convergence θ is calculated by replacing the intersection distance c with the target intersection distance c′ in the equation (1). To shorten the processing time, relation data relating to the target intersection distance c′ calculated according to the equation (1) and the angle of convergence θ may be stored in a nonvolatile memory, and the angle of convergence θ may be calculated from the relation data.

A method of calculating the shift lens drive positions L and R will hereinafter be described.

As illustrated in FIG. 2, as to the relationship between the optical axes VL and VR and the angle of convergence θ, the optical axes VL and VR are oriented inwardly by an angle of θ/2.

Accordingly, the shift lens drive positions L and R are arranged at positions allowing the optical axes VL and VR to be oriented inwardly by the angle of θ/2.

The convergence angle controller 107 calculates the shift lens drive positions L and R based on the operational expression of the shift lens drive positions L and R and the angles of the optical axes VL and VR.

To shorten the processing time, relation data between the shift lens drive position and the angle of the optical axis may be stored in the nonvolatile memory, the shift lens drive position may be calculated from the relationship data.

Furthermore, relation data between the target intersection distance c′ and the shift lens drive positions L and R may be stored in the nonvolatile memory, and the shift lens drive position may be calculated from the relation data and the target intersection distance c′.

As described above, a stereoscopic image having a smooth protrusion amount relative to movement of the object to be shot by the cameraperson can be automatically calculated from the image pickup condition, the viewing condition, the object distance, the track delay amount and the tracking offset amount, according to the condition set by the cameraperson.

### Embodiment 2

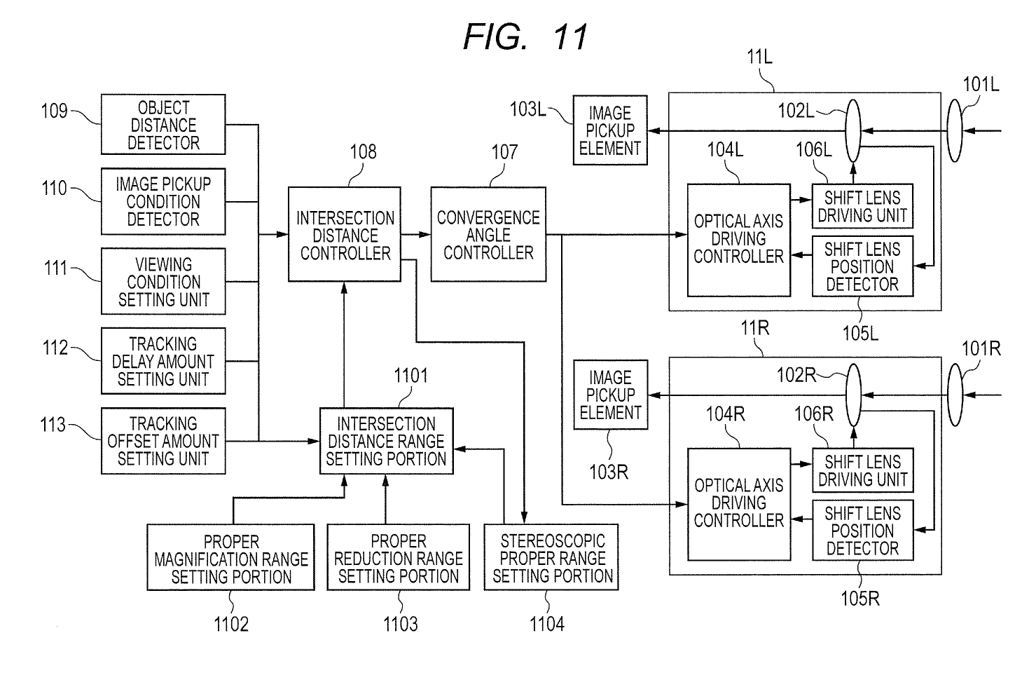

Next, referring to FIG. 11, a stereoscopic image pickup apparatus of a second embodiment of the present invention will be described.

FIG. 11 is a configurational block diagram of this embodiment. The identical symbols are assigned to configurational elements analogous to those in FIG. 1.

An intersection distance range setting portion 1101 sets a range of the intersection distance. A proper magnification range setting portion 1102 sets a proper magnification range, which is a range of the magnification ratio between the size in view of the stereoscopic virtual image x and the actual size of the imaged object. A proper reduction range setting portion 1103 sets a proper reduction range, which is a range of the compression ratio between the depth range in view of the stereoscopic virtual image x and the actual depth range of the imaged object. A stereoscopic proper range setting portion 1104 sets a stereoscopic view proper range, which is the difference between the angle of convergence Ex and the angle of convergence Es, such that the difference between the angle of convergence Ex and the angle of convergence Es falls within a range allowing the viewer to comfortably enjoy a stereoscopic view. The proper magnification range setting portion 1102, the proper reduction range setting portion 1103 and the stereoscopic proper range setting portion 1104 each include a setting display and a switch.

An operation of Embodiment 2 will hereinafter be described.

The proper magnification range setting portion 1102 outputs the proper magnification range to the intersection distance range setting portion 1101. The intersection distance range setting portion 1101 calculates a proper magnification intersection distance range based on the proper magnification range. The proper magnification intersection distance range will be described later.

The proper reduction range setting portion 1103 outputs the proper reduction range to the intersection distance range setting portion 1101. The intersection distance range setting portion 1101 calculates the proper reduction intersection distance range based on the proper reduction range. The proper reduction intersection distance range will be described later.

The stereoscopic proper range setting portion 1104 outputs the stereoscopic view proper range to the intersection distance range setting portion 1101. The intersection distance range setting portion 1101 calculates a stereoscopic proper intersection distance range based on the stereoscopic proper range.

The intersection distance range setting portion 1101 calculates a final intersection distance range satisfying all the proper magnification range, the proper reduction range and the stereoscopic view proper range, from the proper magnification range, the proper reduction range and the stereoscopic view proper range, and outputs the calculated range to the intersection distance controller 108. The intersection distance controller 108 calculates the target intersection distance c′ again such that the target intersection distance c′ falls within the final intersection distance range, and outputs the calculated distance to the convergence angle controller 107.

A method of calculating the proper magnification intersection distance range will hereinafter be described.

As illustrated in FIG. 6, the viewer recognized that the stereoscopic virtual image x is at the position of the protrusion amount n acquired according to the equation (2) owing to an optical illusion. However, the stereoscopic virtual image x is also an image on the screen surface. Accordingly, even the stereoscopic virtual image x approaching the user by the protrusion amount n owing to the optical illusion, the images on the screen itself actually viewed by the right and left eyes are not changed. Accordingly, in the case of shooting an object distant by the same object distance mx at the same angle of view, the larger the protrusion amount n becomes due to the increase in the variation in the intersection distance to cause the position of the virtual image positioned in front of the careen more away from the screen, the more the viewer recognizes the stereoscopic virtual image x reduced. In other words, the viewer recognizes that a virtual image in front of the screen is a reduced image and a virtual image beyond the screen is an enlarged image.

Accordingly, the range of variation in the magnification ratio of the stereoscopic virtual image x can be controlled within a range allowing the viewer to view the image without uncomfortable feeling (hereinafter called a longitudinally and laterally scaling proper range) by controlling the protrusion amount n within the prescribed range. Here, the magnification ratio includes the case of reduction on a virtual image in front of the screen (the viewer side) (magnification ratio<1) and the case of magnification on a virtual image beyond the screen (magnification ratio>1).

More specifically, the magnification ratio in view of the stereoscopic virtual image x is calculated, according to the equation (2), based on the image pickup condition, such as the intersection distance that is the distance to the object being imaged, and the viewing condition, such as the distance from the viewer to the screen (viewing distance). The calculated magnification ratio has a value proportional to the protrusion amount n. The intersection distance range setting portion 1101 calculates a range of the intersection distance c that allows the magnification ratio in view of the stereoscopic virtual image x concerning the actual size of the object to fall within the proper magnification range set by the proper magnification range setting portion (proper magnification range setting unit) 1102, as the proper magnification intersection distance range.

A method of calculating the proper reduction intersection distance range will hereinafter be described.

As illustrated in FIG. 6, if the stereoscopic virtual image x is at the position of the protrusion amount n acquired according to the equation (2), an optical illusion is caused. The depth of the stereoscopic virtual image x also depends on the protrusion amount n. Accordingly, if the intersection distance c is longer than the viewing distance m, the viewer recognizes the virtual image as the stereoscopic virtual image x without depth. In contrast, if the intersection distance c is shorter than the viewing distance m, the viewer recognizes the virtual image as the stereoscopic virtual image x having an increased depth.

As described above, the depth compression ratio of the stereoscopic virtual image x in view is calculated, according to the equation (2), based on the image pickup condition, such as the intersection distance that is the distance to the object, and the viewing condition, such as the distance from the viewer to the screen (viewing distance). In actuality, the compression ratio is calculated according to the ratio between the intersection distance and the viewing distance. The intersection distance range setting portion 1101 calculates the range of the intersection distance c that allows the depth compression ratio in view of the stereoscopic virtual image x relative to the actual size of the object to fall within the proper reduction range set by the proper reduction range setting portion (proper reduction range setting unit) 1103, as the proper reduction intersection distance range.

The intersection distance range setting portion 1101 calculates the final intersection distance range as a range satisfying all the intersection distance ranges, including the proper magnification intersection distance range, the proper reduction intersection distance range and the stereoscopic proper intersection distance range. Instead, a unit for setting a degree of priority on each intersection distance range and for switching between validity and invalidity (intersection distance range selection setting unit) may be provided to determine the final intersection distance range according to the setting by the setting unit.

With the stereoscopic image pickup apparatus described above, a stereoscopic image having a protrusion amount intended by the cameraperson can be automatically picked up without picking up a stereoscopic image causing uncomfortable feeling and a stereoscopic image making the viewer tired.

The exemplary embodiments of the present invention have thus been described. However, the present invention is not limited to these embodiments, but can be variously modified and changed within the scope of the gist.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-219528, filed Oct. 3, 2011, which is hereby incorporated by reference herein in its entirety.

What is claimed is:

1. A stereoscopic image pickup apparatus, comprising:
two optical systems arranged having a binocular disparity;
image pickup units for picking up images of an object from the respective two optical systems;
a convergence angle driver for changing directions of optical axes of the two optical systems, and changing intersection distances from the two optical systems to a position at which the optical axes of the two optical systems intersect with each other;
an object distance detecting unit for detecting an object distance information that is information on an object distance;
an intersection distance controller for computing the intersection distance in a fusion limit range that is a stereoscopically viewable range based on the object distance and an image pickup condition; and
a convergence angle controller for controlling the convergence angle driver based on the object distance and a track delay amount set to cause the intersection distance fall within the fusion limit range such that the intersection distance tracks the object distance with a delay by the track delay amount.

2. The stereoscopic image pickup apparatus according to claim 1, further comprising:
a viewing condition setting unit for setting a viewing condition under which a viewer views a picked up stereoscopic image; and
an intersection distance controller for computing the intersection distance in the fusion limit range that is the stereoscopically viewable range, based on the object distance, the image pickup condition, and the viewing condition,
wherein the convergence angle controller controls the convergence angle driver such that the intersection distance tracks the object distance based on the object distance and the track delay amount set to cause the intersection distance fall within the fusion limit range.

3. The stereoscopic image pickup apparatus according to claim 2, wherein the image pickup condition includes at least any one of a base length, an angle of view and a depth of field.

4. The stereoscopic image pickup apparatus according to claim 2, wherein the viewing condition includes at least any one of a pupil distance of the viewer, a viewing distance that is a distance between a display of displaying the stereoscopic image and the viewer, and a magnification ratio of the viewed image.

5. The stereoscopic image pickup apparatus according to claim 1, further comprising a track delay setting unit for setting the track delay amount.

6. The stereoscopic image pickup apparatus according to claim 5, wherein the track delay amount is determined based on at least one of the image pickup condition and the viewing condition.

7. The stereoscopic image pickup apparatus according to claim 1, wherein, when the convergence angle controller controls the convergence angle driver such that the intersection distance tracks the object distance, the track delay amount is a coefficient of a low-pass filter which is multiplied to a difference between the object distance and the intersection distance.

8. The stereoscopic image pickup apparatus according to claim 1, wherein the convergence angle controller controls the convergence angle driver such that the intersection distance tracks the object distance with a tracking offset amount that is a prescribed difference with respect to the object distance.

9. The stereoscopic image pickup apparatus according to claim 8, further comprising a tracking offset amount setting unit for setting the tracking offset amount.

10. The stereoscopic image pickup apparatus according to claim 8, wherein the tracking offset amount is determined based on at least one of the image pickup condition and the viewing condition.

11. The stereoscopic image pickup apparatus according to claim 3, further comprising:
a unit for calculating a magnification ratio of a stereoscopic virtual image in view based on the object distance, the intersection distance, the image pickup condition, and the viewing condition under which the viewer views the picked up stereoscopic image; and
a proper magnification range setting unit for setting a proper magnification intersection distance range that is a range of the intersection distance for causing a magnification ratio of the stereoscopic virtual image in view fall within a prescribed range,
wherein the convergence angle controller controls the convergence angle driver such that the intersection distance tracks the object distance so as to satisfy the proper magnification intersection distance range.

12. The stereoscopic image pickup apparatus according to claim 3, further comprising:
a unit for calculating a compression ratio of the stereoscopic video in view in a depth direction based on the object distance, the intersection distance, the image pickup condition, and the viewing condition under which the viewer views the picked up stereoscopic video; and
a proper reduction range setting unit for setting a proper reduction intersection distance range that is a range of the intersection distance for causing the compression ratio fall within a prescribed range,
wherein the convergence angle controller controls the convergence angle driver such that the intersection distance tracks the object distance so as to satisfy the proper reduction intersection distance range.

13. The stereoscopic image pickup apparatus according to claim 3, further comprising:
a unit for calculating a protrusion amount that is a distance between the stereoscopic virtual image in view and an image display based on the object distance, the intersection distance, the image pickup condition and the viewing condition; and
a stereoscopic view proper range determination unit for determining a stereoscopic view proper range that is a range of the intersection distance such that the protrusion amount, or the protrusion amount and the protrusion duration falls within a prescribed range based on the protrusion amount, or the protrusion amount and the protrusion duration,
wherein the convergence angle controller controls the convergence angle driver such that the intersection distance tracks the object distance based on the stereoscopic view proper range.

14. The stereoscopic image pickup apparatus according to claim 3, further comprising:
a unit for calculating a magnification ratio of a stereoscopic virtual image in view based on the object distance, the intersection distance, the image pickup condition, and the viewing condition under which the viewer views the picked up stereoscopic image;
a proper magnification range setting unit for setting a proper magnification intersection distance range that is a range of the intersection distance for causing the magnification ratio of the stereoscopic virtual image in view fall within a prescribed range;
a unit for calculating a compression ratio of the stereoscopic image in view in a depth direction based on the object distance, the intersection distance, the image pickup condition, and the viewing condition under which the viewer views the taken stereoscopic image;
a proper reduction range setting unit for setting a proper reduction intersection distance range that is a range of the intersection distance for causing the compression ratio fall within a prescribed range;
a unit for calculating a protrusion amount that is a distance between the stereoscopic virtual image in view and an image display based on the object distance, the intersection distance, the image pickup condition and the viewing condition;
a stereoscopic view proper range determination unit for determining a stereoscopic view proper range that is a range of the intersection distance such that the protrusion amount, or the protrusion amount and the protrusion duration falls within a prescribed range based on the protrusion amount, or the protrusion amount and the protrusion duration;
an intersection distance range selection setting unit for setting priority among and switching between validity and invalidity of the proper magnification intersection distance range, the proper reduction intersection distance range and the stereoscopic view proper range; and
a unit for setting the intersection distance range that sets the intersection distance range based on the proper magnification intersection distance range, the proper reduction intersection distance range and the stereoscopic view proper range in accordance with the intersection distance range selection setting unit,
wherein the convergence angle controller controls the convergence angle driver such that the intersection distance tracks the object distance based on the intersection distance range.
